(19) United States
(12) Patent Application Publication
(10) Pub. No.: US 2017/0339936 A1
(43) Pub. Date: Nov. 30, 2017

(54) Fishing tackle attachment apparatus

(71) Applicant: David L. Simmons, Sevierville, TN (US)

(72) Inventor: David L. Simmons, Sevierville, TN (US)

(21) Appl. No.: 15/606,806

(22) Filed: May 26, 2017

Related U.S. Application Data
(60) Provisional application No. 62/341,815, filed on May 26, 2016.
(60) Provisional application No. 62/449,783, filed on Jan. 24, 2017.

(51) Int. Cl. A01K 91/04; A01K 97/00; A01K 99/00; A01K 91/047; A01K 83/06; A01K 91/03; A01K 85/18

(52) U.S. Cl. CPC A01K 91/04; A01K 99/00; A01K 97/00; A01K 91/047; A01K 91/03; A01K 85/18; A01K 83/06

(57) ABSTRACT

Apparatus for an attachment device for a fishing line. The attachment device includes an in-line snap and a piece of tackle. The in-line snap includes a shank, a bend, and a point. The bend extends from the shank and folds over to join the point at a gap portion where the bend contacts the shank. The point extends away from the shank, forming a channel to receive a continuous section of fishing line. A shaft extends between the shank and the piece of tackle. In various embodiments, a second in-line snap cooperates with the first in-line snap to support a piece of tackle between the two in-line snaps.

### STATEMENT REGARDING FEDERALLY SPONSORED RESEARCH OR DEVELOPMENT

Not Applicable

### BACKGROUND

### 1. Field of Invention

This invention pertains to apparatus for releasably attaching to a fishing line without requiring that the line be cut. In particular, the invention pertains to an in-line attachment device that engages a continuous section of fishing line or a loop formed by knotting the fishing line.

### 2. Description of the Related Art

Tackle, or fishing tackle, is the equipment used by a person when fishing. Many pieces of tackle, such as many sinkers, many floats, and fish hooks, have an eye for securing the tackle to a fishing line. The end of the fishing line is threaded through the eye and a knot is tied to keep the tackle attached to the line. Often times a string of fishing tackles are positioned end to end on the fishing line. For example, a float is attached to the fishing line, a sinker is attached with a leader to the float, and a fish hook is attached to the sinker with another leader. A leader is a short length of fishing line that is attached at each end by knotting.

Some sinkers and bobbers have a through-hole into which the end of the fishing line is threaded. Split shot sinkers have a slot that is crimped around the fishing line, thereby securing the sinker to the line. Some bobbers attach to continuous sections of fishing line by spring-loaded hooks. The hook is pushed away from the body of the bobber and the fishing line is positioned in the throat. The hook is released and spring pressure pulls the hook, and fishing line, against the body of the bobber, holding the bobber captive to the fishing line.

Some fishing tackle are configured with one end to snap into an eye and the other end to attach to soft bait, such as a worm, grub, or other bait-like object made of soft, flexible material. One such device is the HitchHiker sold by TTI-Blakemore Fishing group. The device has an open hook on one end. The open hook has a mouth or gap large enough to engage an eye, such as on a lure, yet small enough to hold the eye captive in the open hook. The gap on the open hook is not closed, but has a space so as to better engage the eye for attaching the device. That is, the gap is open with a space that is larger than the diameter of the typical fishing line and smaller than the diameter of the eye. Opposite the open hook is a loose coil configured to screw into the soft bait, which is typically a silicone-type material. The loose coil is positioned immediately adjacent to the open hook. The loose coil is separated from the open hook only far enough so that the open hook can engage an eye. In this way the soft bait is positioned as close as possible to the eye to which the open hook is attached.

Another type of fishing tackle is a jigging lure or jig, which is a fishing lure with a heavy or sinker body with a hook molded into or attached to the body. A jigging lure is intended to move vertically in the water with a jerky motion, as opposed to spinnerbaits that move horizontally. One type of jigging lure has a pair of eyes extending from the body. One eye is for attaching a fishing line. The other eye is configured to attach to a fish hook. One type of fish hook that is used is the Runkokoukut fish hook sold by VMC International. The Runkokoukut fish hook has an open hook on one end, a bend in the shank near the open hook, and a fish hook at the other end. The Runkokoukut fish hook is intended to be used for a jigging lure where the weighted portion, typically lead, is molded around the shank so that only the loop of the open hook and the fish hook is exposed. Another way of using the Runkokoukut fish hook is to engage an eye on the body of the jig with the open hook with the shaft of the fish hook engaging a soft bait that is positioned immediately adjacent the jig.

### BRIEF SUMMARY

According to one embodiment of the present invention, an attachment device for fishing tackle is provided. In various embodiments, the attachment device includes at least one end that engages a fishing line without requiring the fishing line be first cut. One attachment end is a first, or captive, end that loosely and slideably engages the fishing line. Another attachment end is an in-line snap or securing end.

In various embodiments, the attachment device has a first end and a second end separated by a shaft and/or a piece of tackle. In one embodiment, the first end receives a medial portion of a fishing line and holds that line captive to the device. In one such embodiment, the first, or captive, end is a coil. A continuous section of line is wound around and into the coil.

The second end is an in-line snap or securing end that receives a medial portion of a fishing line and secures that line to the device. A continuous section of line is wrapped around the shank of the in-line snap with at least one wrap passing through the gap and into the throat of the in-line snap. In this way, the attachment device is readily attached to and removed from a continuous section of line without the line being cut or broken. Furthermore, the attachment device is movable along the line or fixed in place, depending upon the number of wraps around the in-line snap. In one embodiment, the attachment device includes two in-line snaps, one on each end.

In various embodiments, a piece of tackle is positioned between the ends of the attachment device. In this way the piece of tackle is readily attached to a fishing line. In various embodiments, the piece of tackle is a sinker, a float, a lure, a hook, an eye, or a device for securing a hook to the line.

In one embodiment, the attachment device includes an in-line snap or securing end and the tackle is a fish hook. The in-line snap allows ready attachment to an eye or fishing line with a knot. For example, the in-line snap is attached to the line with a simple knot having a loop, such as a clinch knot, allowing the attachment device to easily engage the fishing line. In one such embodiment, a keeper is inside the throat of the in-line snap. The keeper prevents the knotted line from sliding out of the in-line snap.

The in-line snap solves the problem of allowing a person to attach a line to fishing tackle under adverse conditions or when the person has a handicap or disability. For example, fishing is often conducted in a wet, cold environment in which the person's hands often become stiff and/or numb. Sometimes the person fishing may have motor control problems, be nervous, or have vision problems. In these cases the in-line snap solves the problem of attaching a fishing line to fishing tackle by allowing the in-line hook to engage a relatively large loop in the fishing line and providing a tactile feedback as the fishing line passes through the closed gap of the in-line snap.

### BRIEF DESCRIPTION OF THE SEVERAL VIEWS OF THE DRAWINGS

The above-mentioned features will become more clearly understood from the following detailed description read together with the drawings in which:

FIG. 1 is a side view of a fishing pole illustrating two embodiments of an attachment device attached to a fishing line.

FIG. 2 is a perspective view of one embodiment of an in-line snap or securing end.

FIG. 3 is a side view of the an in-line snap or securing end shown in FIG. 2.

FIG. 4 is a perspective view of one embodiment of a captive end.

FIG. 5 is a side view of a third embodiment of an attachment device.

FIG. 6 is a side view of a fourth embodiment of an attachment device.

FIG. 7 is a side view of a fifth embodiment of an attachment device.

FIG. 8 is a partial cross-sectional view of a sixth embodiment of an attachment device.

FIG. 9 is a symbolic view of one embodiment of an in-line snap engaging a continuous section of fishing line.

FIG. 10 is a side view of an embodiment of an attachment device with a pair of in-line snaps on opposite sides of a piece of tackle illustrated as a single bead.

FIG. 11 is a side view of an embodiment of an attachment device with a pair of in-line snaps on opposite sides of a piece of tackle illustrated as a pair of beads.

FIG. 12 is an exploded view of yet another embodiment of an attachment device with a single in-line snap attached to a piece of tackle illustrated as a float.

FIG. 13 is a perspective view of another embodiment of an attachment device.

FIG. 14 is a side view of one embodiment of a tackle with the attachment device similar to that shown in FIG. 13.

FIG. 15 is a perspective view of yet another embodiment of an attachment device.

FIG. 16 is a side view of one embodiment of an attachment device that includes a tackle with the attachment device of FIG. 15.

FIG. 17 is a side view of another embodiment of an attachment device that includes a tackle with the attachment device of FIG. 15.

FIG. 18 is a side view of one embodiment of a drop sinker with one embodiment of an attachment device.

FIG. 19 is a side view of another embodiment of an attachment device.

FIG. 20 is a perspective view of still another embodiment of an attachment device.

FIG. 21 is an end view of the embodiment of the attachment device of FIG. 20.

FIG. 22 is a side view of one embodiment of a piece of tackle with the attachment device of FIG. 20.

FIG. 23 is an end view the tackle shown in FIG. 22.

FIG. 24 is a side view of one embodiment of an attachment device that combines a fish hook with an in-line snap.

FIG. 25 is a side view of another embodiment of an attachment device that combines a fish hook with another embodiment of an in-line snap.

FIG. 26 is a side view of still another embodiment of an attachment device that combines a fish hook with yet another embodiment of an in-line snap.

### DETAILED DESCRIPTION

Apparatus for releasably attaching tackle to a fishing line is disclosed. The attachment device is generally indicated as 100, with particular embodiments and variations shown in the figures and described below having an alphabetic suffix, for example, 100-A, 100-B. As used herein, tackle and a piece of tackle 126 includes equipment used when fishing wherein that equipment is intended to be attached to or suspended from fishing line 104. This application claims the benefit of U.S. provisional application number 62/341,815, filed May 26, 2016, and U.S. provisional application number 62/449,783, filed Jan. 21, 2017. These two provisional applications are hereby incorporated by reference.

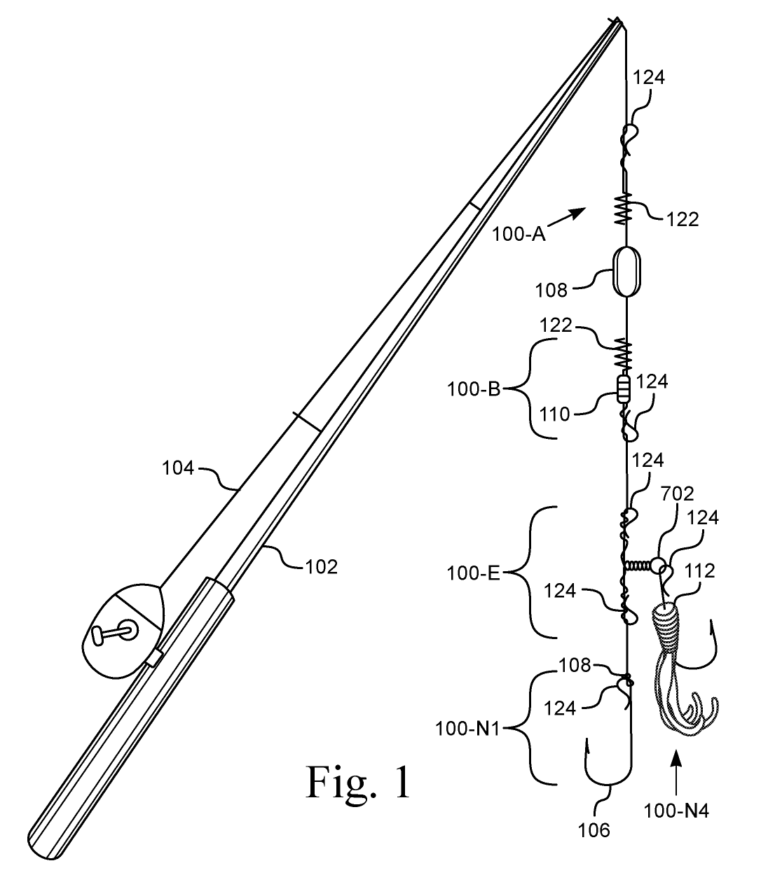

FIG. 1 illustrates a side view of a fishing pole 102 illustrating various embodiments of attachment devices 100-A, 100-B, 100-E, 100-N1, 100-N4. The fishing pole 102 includes a fishing line 104 strung from a reel to the tip of the pole 102. The fishing line 104 is shown dangling from the end of the pole 102 and the continuous length of fishing line 104 is terminated with a fish hook 106.

Attached to the fishing line 104 are a pair of opposing attachment devices 100-A, 100-B with a float 108 therebetween. The attachment devices 100-A, 100-B are releasably attached to the continuous length of fishing line 104 and separated by a distance sufficient for the float 108 to move and allow a weight on the fishing line 104 to move between two desired depths. The illustrated float 108 is the type that is made of a buoyant material, such as wood or foam, that has a tube through which the fishing line 104 passes. The illustrated configuration allows for the float 108 to freely move between the two attachment devices 100-A, 100-B. In this way when the float 108 is suspended in water, the hook 106 is restricted vertically by the distance between the two attachment devices 100-A, 100-B.

One attachment device 100-A has a first, coil, end 122 and a second, in-line snap, end 124. The first end 122 receives a medial portion of the fishing line 104 and holds that line 104 captive to the device 100-A. The second end 124 is an in-line snap or securing end 124 that receives a medial portion of the fishing line 104 and secures that line 104 to the device 100-A. Between the two ends 122, 124 is a shaft 202. The fishing line 104 is held captive at the first coil end 122 by being restrained by the windings 204 enclosing the line 104. The line 104 engages the coil 122 by first positioning the line 104 adjacent the piece of tackle 126 and extending parallel to the longitudinal axis of the coil 122. The line 104 is then moved toward the shaft 202 and wound between the windings 204 of the coil 122. In this way a continuous section of the line 104 becomes captive within the windings 204. The engagement of the line 104 with the captive end 122 keeps the device 100 aligned with the line 104 when the line 104 is taut.

A second attachment device 100-B is similar to the first attachment device 100-A, but includes a body 110 between the ends 122, 124. The attachment device 100-B includes a captive or coil end 122, a piece of tackle 126, and a securing or in-line snap end 124. In one embodiment, the device 100-B has a single shaft 202 to which the body 110 or piece of tackle 126 is attached. In another embodiment, the device 100-B has a pair of shafts 202 in which each section of shaft 202 is attached to one end 122, 124. The shaft sections 202 are then fixed to the ends of the body 110 or piece of tackle 126. The body 110 is similar to the body 802 shown in FIG. 8. The body 110 is substantially cylindrical with rounded ends and ribs. The body 110 provides a gripping surface to aid in attaching and removing the attachment device 100-B from the line 104. The rounded ends of the body 110 minimizes the risk of snagging the line 104 and grass or other object external to the device 100-B.

Attached to the fishing line 104 between the attachment devices 100-A, 100-B and the hook 106 is another embodiment of an attachment device 100-E such as illustrated in FIG. 7. The attachment device 100-E includes a pair of in-line snaps or securing ends 124 with an eye 702 extending away from the line for attachment of a leader or other tackle. One such tackle is the attachment device 100-N4, which includes a hook 106 with a grub 112 having swirl tails. The device 100-N4 has an in-line snap 124 that engages the eye 702 of the attachment device 100-E. Another way of attaching the device 100-N4 is to tie a butterfly loop in the fishing line 104 and slide the loop of the knot into the in-line snap 124 of the device 100-N4.

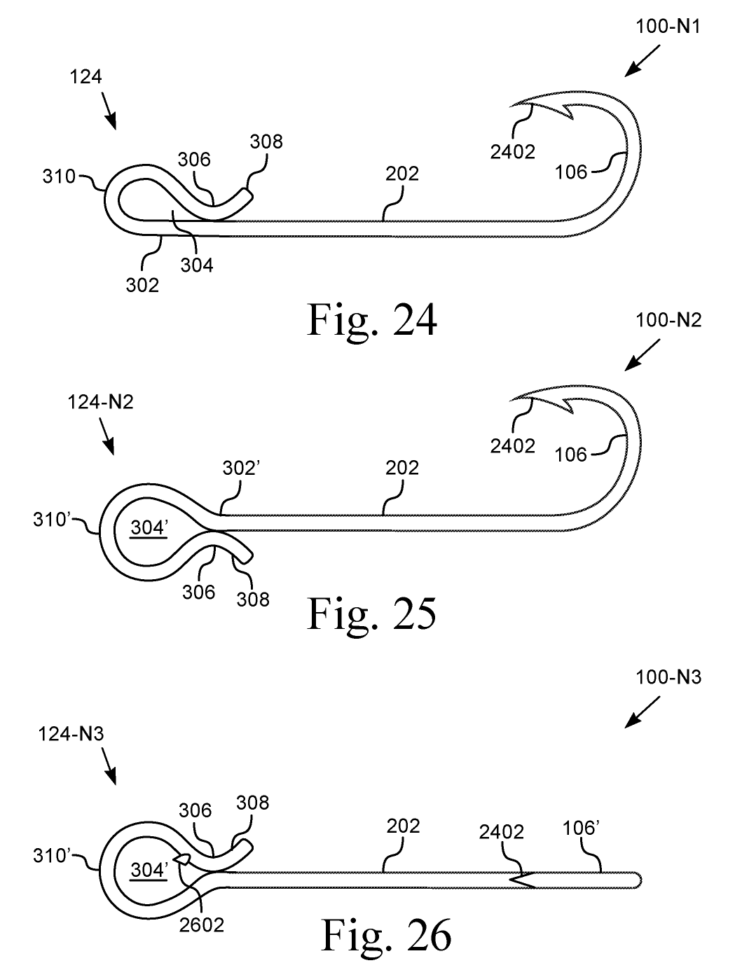

At the end of the fishing line 104 is another embodiment of an attachment device 100-N1 such as the one illustrated in FIG. 24. The attachment device 100-N1 includes a fish hook 106 with an in-line snap 124, which is attached to the fishing line 104 with a knot 108. The knot 108 is tied with a loop that engages the in-line snap 124 at the end of the shaft of the hook 106. One such knot is a clinch knot, which is commonly used to tie a fishing line 104 to a conventional fish hook. With a conventional fish hook, the line 104 must be threaded through the eye of the hook before the know it tied. Threading the end of a fishing line 104 through the eye of the fish hook is often difficult for persons with a handicap or who are nervous or have bad eyesight. The in-line snap 124 of the attachment device 100-N1 solves that problem by allowing the in-line snap 124 to engage a loop formed in the fishing line 104, where the loop is substantially larger than the eye of a conventional fish hook.

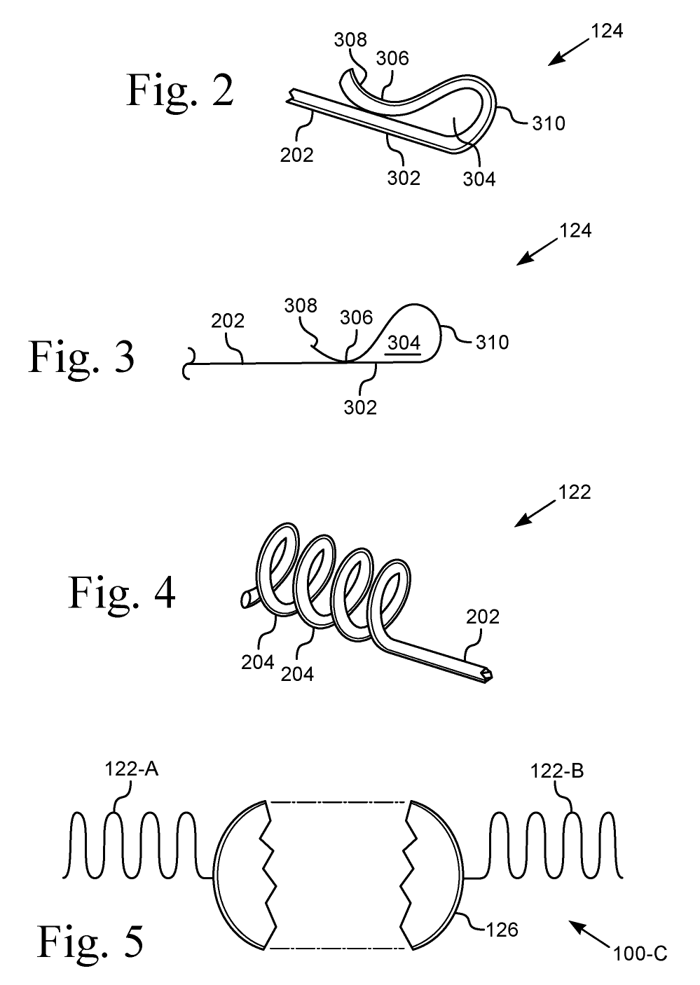

FIG. 2 illustrates a perspective view of one embodiment of an in-line snap or securing end 124. FIG. 3 illustrates a side view of the in-line snap 124 shown in FIG. 2.

The in-line snap or securing end 124 is a hook device configured to attach to a continuous section of fishing line 104 or a loop formed by knotting the fishing line 104. The in-line snap 124 includes a shank 302, a throat 304, bend 310, a gap 306, and a point 308. The shank 302 is a section between the shaft 202 and the bend 310. The bend 310 extends from one end of the shank 302 and loops around to the gap 306. The looping of the bend 310 defines the throat 304. The throat 304 is the open area inside the bend 310 extending to the gap 306. The bend 310 connects to the point 308, which is the distal portion that extends from the bend 310. The point 308 and the distal end of the bend 310 define the gap. The distal end of the point 308 extends away from the shaft 202 and shank 302. The point 308 defines a guide or channel that receives a portion of the fishing line 104 and guides the passage of the fishing line 104 into the throat 304.

In the illustrated embodiment, the in-line snap 124 is a closed hook in which the gap 306 has substantially zero or no space between the end of the bend 310 and the shank 302, that is, a portion of the in-line snap 124 where the point 308 joins the bend 310 is in contact with or is very close to the shank 302. With this configuration the gap 306 expands to receive the fishing line 104 when the fishing line 104 is forced between the shank 302 and the portion of the in-line snap 124 adjacent the point 308. In one such embodiment, the bend 310 is biased toward the shank 302. The point 308 is upturned to provide a space to receive the line 104 before the line enters the gap 306. With the gap 306 having no space between the shank 302 and the bend 310, a fishing line 104 is held captive in the throat 304 unless sufficient lateral force is applied to the line 104 to force the gap 306 to open, that is, the distal end of the bend 310 separates from the shank 302 a distance sufficient for the line 104 to pass. In another embodiment, the gap 306 is less than the thickness of the fishing line 104. In such an embodiment the gap 306 still expands to receive the fishing line 104, but less force is required to expand the gap 306 for the line 104 to pass.

The shaft 202 extends away from the shank 302 of the in-line snap 124. In various embodiments, the shaft 202 connects two ends 122, 124, 124-A, 124-B. In other embodiments the shaft 202 has one end attached to the in-line snap 124. The other end of the shaft 202 is attached to a piece of fishing tackle 126, such as a float, sinker, lure, eye, or other device. The length of the exposed portion of the shaft 202 is sufficiently long for the fishing line 104 to be secured to the in-line snap 124 by wrapping. If the length of the shaft 202 is too short, tension on the line 104 causes the attachment device 100 to become unstable. The length of the shaft 202 typically varies between ¾ to 1½ inches. In various embodiments, the distance between the point 308 and the piece of tackle 126 is between ¾ and 1½ inches. In this way, there is sufficient space to wrap the line 104 around the exposed shaft 202.

In various embodiments, the in-line snap 124 is formed of steel, such as vanadium or carbon steel. In one embodiment, the in-line snap 124 is formed of a stiff wire, for example stainless steel or similar non-corrosive material. A wire thickness between 0.025 and 0.030 inches has been found to provide sufficient strength and resiliency. In another embodiment, the in-line snap 124 is formed of a resilient plastic or polymer material.

FIG. 4 illustrates a perspective view of one embodiment of a captive end 122, such as used in the attachment devices 100-A, 100-B illustrated in FIG. 1. The first or captive end 122 is a coil made of windings 204. In the illustrated embodiment, the coil 122 has four windings 204. The number of windings 204 varies in various embodiments. Two to four windings are typically sufficient to hold the fishing line 104 without requiring undue effort in engaging the line 104 in the coil end 122.

A length of approximately ¼ inch works well for length of the windings 204 of the captive end 122. In one embodiment, the spacing between windings 204 is equal to or greater than the diameter of the fishing line 104. In this way the fishing line 104 readily passes between the windings 204 when the line 104 is wound around the captive end 122. In another embodiment, the spacing between windings 204 is equal to or less than the diameter of the fishing line 104. In this way the fishing line 104 forces adjacent windings 204 to separate or spring apart when the line 104 is forced between the windings 204 when the line 104 is wound around the captive end 122.

In one embodiment, the captive end 122 is formed of a stiff wire, for example stainless steel or similar non-corrosive material. A wire thickness between 0.025 and 0.030 inches has been found to provide sufficient strength and resiliency. In another embodiment, the captive end 122 is formed of a resilient plastic or polymer material.

FIG. 5 illustrates a side view of a third embodiment of an attachment device 100-C. The attachment device 100-C includes a pair of opposing captive ends 122-A, 122-B with a piece of tackle 126 therebetween. The pair of captive ends 122-A, 122-B allows the device 100-C to slide along the fishing line 104 after being attached to the line 104. The pair of captive ends 122-A, 122-B allows the device 100-C to be attached to a continuous section of fishing line 104, that is, the fishing line 104 is uncut and unbroken. The piece of tackle 126, in various embodiments, is a sinker, a float, an eye, a soft bait, or other equipment used with a fishing line 104.

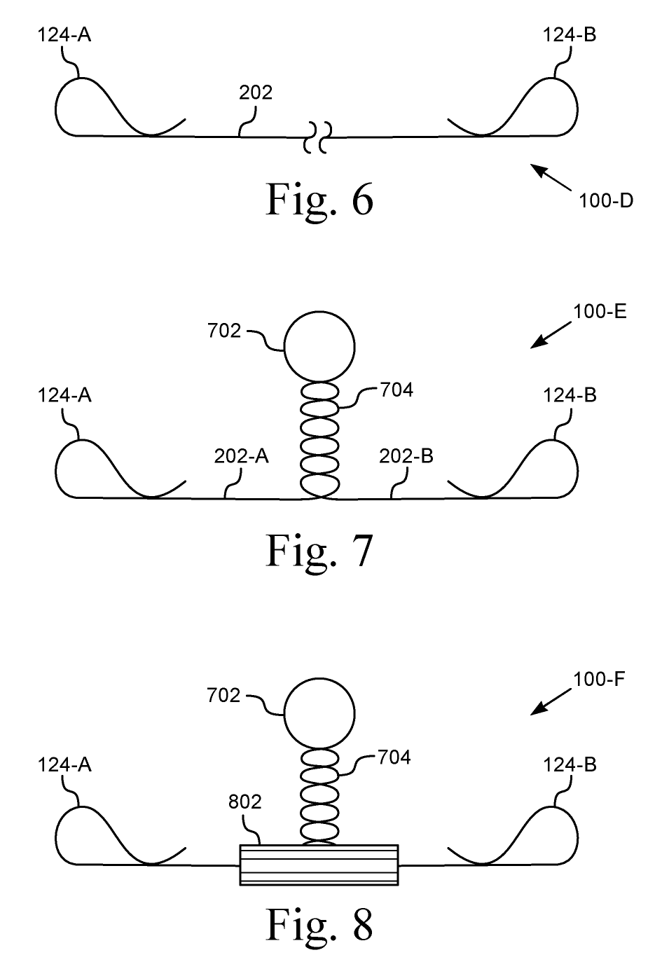

FIG. 6 illustrates a side view of a fourth embodiment of an attachment device 100-D. The attachment device 100-D includes a pair of opposing securing ends 124-A, 124-B with a shaft 202 therebetween. The pair of in-line snap ends 124-A, 124-B allows the device 100-D to be secured at a specific location on the fishing line 104 after being attached to the line 104. The pair of securing ends 124-A, 124-B allows the device 100-D to be attached to a continuous section of fishing line 104, that is, the fishing line 104 is uncut and unbroken.

FIG. 7 illustrates a side view of a fifth embodiment of an attachment device 100-E. The attachment device 100-E includes a pair of opposing in-line snaps 124-A, 124-B, such as illustrated in FIG. 6. Additionally, the device 100-E includes an eye 702. The eye 702 is positioned a distance away from the shaft sections 202-A, 202-B. In this way, anything attached to the eye 702 is less liable to inadvertently engage the -line snaps 124-A, 124-B. The eye 702 of the device 100-E allows a leader or a stringer, a hook, or other tackle to be readily secured at a specific location on the fishing line 104. The pair of in-line snaps 124-A, 124-B allows the device 100-E to be attached to a continuous section of fishing line 104, that is, the fishing line 104 is uncut and unbroken.

The illustrated attachment device 100-E is formed by twisting the medial portion of the shaft 202 such that a stalk 704 of twisted wire is formed with the eye 702 made from a loop of the wire. The shaft 202 is divided into two sections 202-A, 202-B with the stalk 702 extending away from the shaft sections 202-A, 202-B. In other embodiments, a tackle device 126 with an eye 702 is positioned between the two ends 124-A, 124-B.

FIG. 8 illustrates a side view of a sixth embodiment of an attachment device 100-F. The attachment device 100-F includes the attachment device 100-E illustrated in FIG. 7 plus a body 802 that covers a portion of the shaft sections 202-A, 202-B, including where the stalk 704 extends from the shaft sections 202-A, 202-B. The body 802 prevents or minimizes the risk of snags and also adds strength to the device 100-F.

In one embodiment, the body 802 is cylindrical. In another embodiment, the body 802 includes ribs, such as shown on the body 110 illustrated in FIG. 1. The body 802 provides a gripping surface to aid in attaching and removing the attachment device 100-F from the line 104.

In another embodiment, the attachment device 100 includes the pair of in-line snaps 124-A, 124-B with a body 110, 802 therebetween. In such an embodiment, there is no stalk 704 and no eye 702. The body 802 provides a surface that is readily gripped by the user while wrapping the line 104 around each of the in-line snaps 124-A, 124-B. In this way the attachment device 100 has a small size that is useful as a line stop 100-A, 100-B such as those illustrated in FIG. 1.

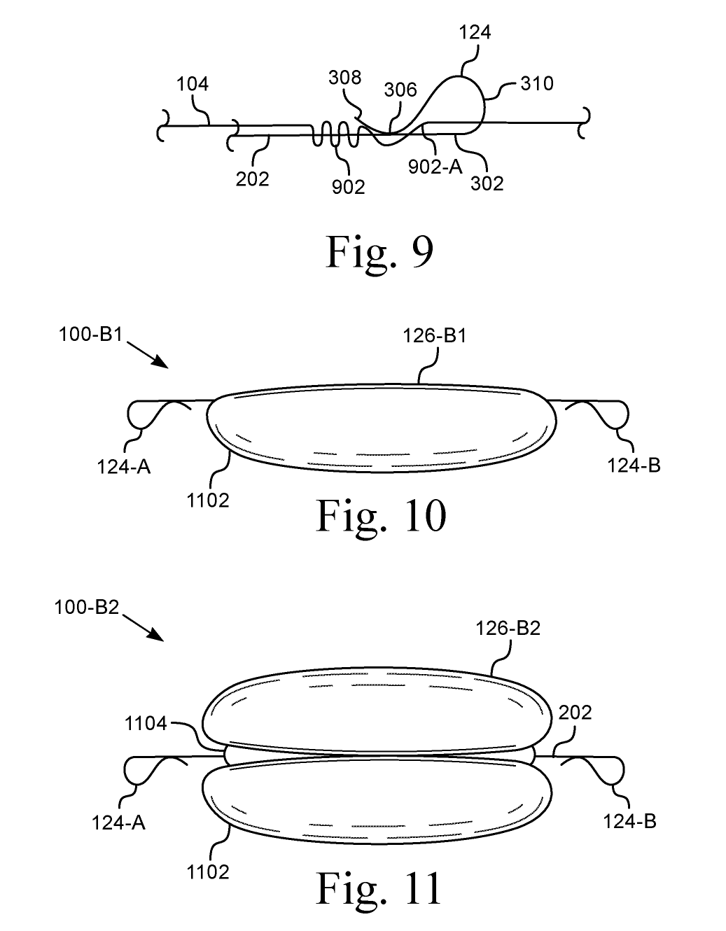

FIG. 9 illustrates a symbolic view of a portion of the fishing line 104 engaging the in-line snap or securing end 124 of an attachment device 100. In one embodiment, a method of engaging the in-line snap 124 with the fishing line 104 includes the step of positioning the in-line snap 124 parallel to a portion of the fishing line 104. The next step is wrapping the fishing line 104 around the shaft 202 and shank 302 of the in-line snap end 124 with a desired number of wraps 902, 902-A.

The fishing line 104 is secured to the in-line snap or securing end 124 by wrapping the line 104 around the shaft 202 with at least the final wrap 902-A pulled past the gap 306 into the throat 304. As the final wrap 902-A is pulled past the gap 306 into the throat 304, the in-line snap 124 makes a snapping or clicking noise after the gap 306 opens to allow the line 104 to pass and when the bend 310 then springs back to the shank 302, thereby closing the gap 306 with a snap.

The number of wraps 902 of the line 104 around the securing end 124 determines how securely the attachment device 100 is held to the fishing line 104. For example, generally, four or more wraps 902 around shaft 202 of the securing end 124 holds the attachment device 100 securely to the fishing line 104. Less than four wraps 902 around the securing end 124 allows for a frictional sliding engagement of the device 100 with the line 104. Generally, two to four wraps 902 are sufficient to secure the attachment device 100 while still allowing the device 100 to be forcibly moved along the length of the line 104 by application of a force by the user. During the normal use of the device 100, the device 100 is held in place. A frictional sliding engagement is where the device 100 is held in place with a frictional force that is greater than the force the device 100 can apply relative to the line 104 with the device's 100 normal, intended use. The device 100 slides relative to the line 104 only by application of an outside force such as a person grasping the device 100 and pushing or pulling the device 100 relative to the line 104. Increasing the number of wraps 902 increases the amount of outside force required to move the device 100 relative to the line 104.

A method of attaching the device 10 to a continuous section of line 104 is to hold a portion of the line 104 in position proximate the device 100 while moving the portion of the line proximate the hook end 124 such that the portion of line 104 is wrapped around the shaft 202 proximate the point 308. The portion of line 104 is moved so as to form a desired number of wraps 902, numbering at least two wraps 902. After the wraps 902 are made, the portion of line extending away from the hook end 124 is pulled away from the in-line snap end 124 such that the line 104 is drawn through the gap 306 with the line 104 passing through the throat 304.

The method of securing a device 100 to a line 104 such that the device 104 is movable upon demand includes first wrapping between two to four turns of line 104 around the shaft 202 proximate the point 308 and then pulling the line 104 past the gap 306 into the throat 304. With the device 100 attached to the line 104, the line 104 is held taut proximate the device 100 and a force is applied to the device 104 in the direction of the desired movement, whereby the hook end 124 slides relative to the line 104. A method of positioning the device 100 on the fishing line 104 after being secured includes the steps of grasping the fishing line 104, grasping the device 100, and then moving the fishing line 104 and device 100 apart by applying a tension force. Such method of positioning is performed after ensuring that the fishing line 104 has a number of wraps 902 sufficient to allow the device 100 to move relative to the fishing line 104.

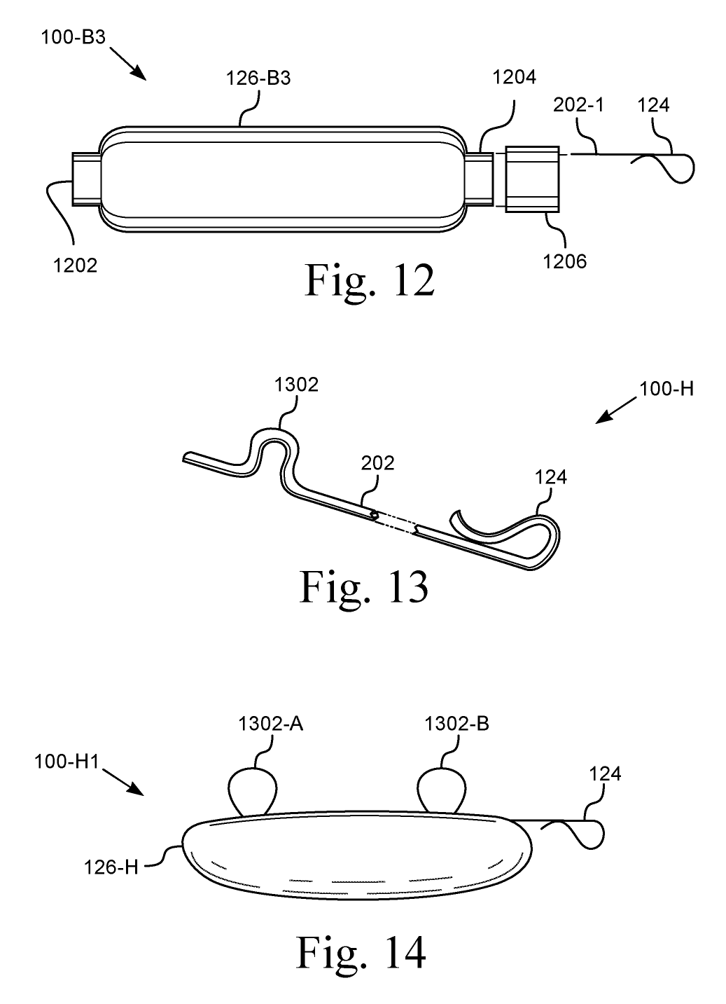

FIG. 10 illustrates a side view of another embodiment of an attachment device 100-B1 with a pair of in-line snaps 124-A, 124-B on opposite sides of a piece of tackle 126-B1 illustrated as a bead 1102. The attachment device 100-B1 includes a first securing end 124-A, a piece of tackle 126-B1 and a second securing end 124-B. In various embodiments, the piece of tackle 126 is the illustrated single bead 1102, the pair of beads 1102 such as illustrated in FIG. 11, a float 126-B3 such as illustrated in FIG. 12, an eye 702 such as illustrated in FIGS. 7 & 8, a fish hook 106 such as illustrated in FIGS. 1, 24-26, or another type of tackle used for fishing. In these various embodiments, the attachment device 100-B, 100-B1, 100-B2, 100-B3, 100-E, 100-F includes a single in-line snap 124, 124-A or a pair of in-line snaps 124-A, 124-B.

In the illustrated embodiment, the attachment device 100-B1 is configured for a fishing line 104 to be secured to each end 124-A, 124-B of the device 100-B1. In one embodiment, the securing ends 124-A, 124-B are configured as the attachment device 100-D illustrated in FIG. 6. In the illustrated embodiment, the piece of tackle 126-B1 is a glass bead or cabochon in which the shaft 202 is either embedded in a channel on the flat portion of the bead 1102 or the shaft 202 is secured or glued to the flat portion of the bead 1102.

FIG. 11 illustrates a side view of an embodiment of an attachment device 100-B2 with a pair of in-line snaps 124-A, 124-B on opposite sides of a piece of tackle 126-B2 illustrated as a pair of beads 1102. The attachment device 100-B2 includes a first securing end 124-A, a piece of tackle 126-B2, and a second securing end 124-B. In the illustrated embodiment, the attachment device 100-B2 is configured for a fishing line 104 to be secured to each end 124-A, 124-B of the device 100-B2. FIG. 11 also illustrates that the piece of tackle 126-B2 is a pair of glass beads 1102 joined together with an adhesive 1104. Between the two glass beads 1102 is the shaft 202 joining the two ends 124-A, 124-B.

FIG. 12 illustrates an exploded view of yet another embodiment of an attachment device 100-B3 with a single in-line snap 124 attached to a piece of tackle 126 illustrated as a float 126-B3. The attachment device 100-B3 includes a passageway 1202, a piece of tackle 126-B3, and a securing end 124. In the illustrated embodiment, the piece of tackle 126-B3 is an elongated float or sinker with a passageway or channel 1202 extended between opposite ends. On at least one end extends a nipple 1104. The piece of tackle 126-B3 is attached to the fishing line 104 in a conventional manner, such as by feeding an end of the fishing line 104 through the passageway 1202. The attachment device 100-B3 has a frictional sliding engagement with the line 104. In another embodiment, the piece of tackle 126-B3 does not include a passageway. In such an embodiment, the fishing line 104 attaches to the in-line snap 124 and the piece of tackle 126-B3 dangles from the fishing line 104.

The attachment device 100-B3 also includes a collar 1206 and a securing end 124 with a section of shaft 202-1. The collar 1206 fits over the nipple 1204. The section of shaft 202-1 of the securing end 124 fits between the nipple 1204 and the collar 1206, thereby fixing the in-line snap 124 in place.

In another embodiment, the in-line snap 124 attaches directly to the piece of tackle 126-B3 without the collar 1206. For example, the end of the shaft 202-1 is inserted in an opening in the end of the piece of tackle 126-B3 and secured in place with an adhesive.

FIG. 13 is a perspective view of another embodiment of an attachment device 100-H. The device 100-H has a first end 124 and one or more eyes 1302 that define the second end. Between the hook end 124 and the eye 1302 is a shaft 202. The eye 1302 is dimensioned to receive a fishing line 104 or attachment to a fishhook. In the illustrated embodiment, an end of the fishing line 104 must be threaded through the eye 1302. The eye 1302 is a retainer for the fishing line 104 that keeps the fishing line 104 running in a line from the inline snap 124. In this way, the fishing line 104 remains parallel to the shaft 202.

FIG. 14 is a side view of one embodiment of a tackle 126-H with an attachment device 100-H1 similar to that of FIG. 13. The attachment device 100-H1 is attached to tackle 126-H, such as the illustrated sinker, which has a substantially flat surface on one side and a rounded surface on the other. Protruding from the flatter surface is an eye 1302-A located at the opposite end of the tackle 126-H than the first end 124. In this way the fishing line 104 is routed through the eye 1302-A and secured to the hook end 124, thereby supporting the tackle 126-H in a substantially parallel configuration with the fishing line 104.

For a piece of tackle 126-H with a long body, a second eye 1302-B is useful for supporting the tackle 126-H along the fishing line 104. The embodiment of the device 100-H1 shown in FIG. 14 includes two eyes 1302-A, 1302-B through which the fishing line 104 is threaded.

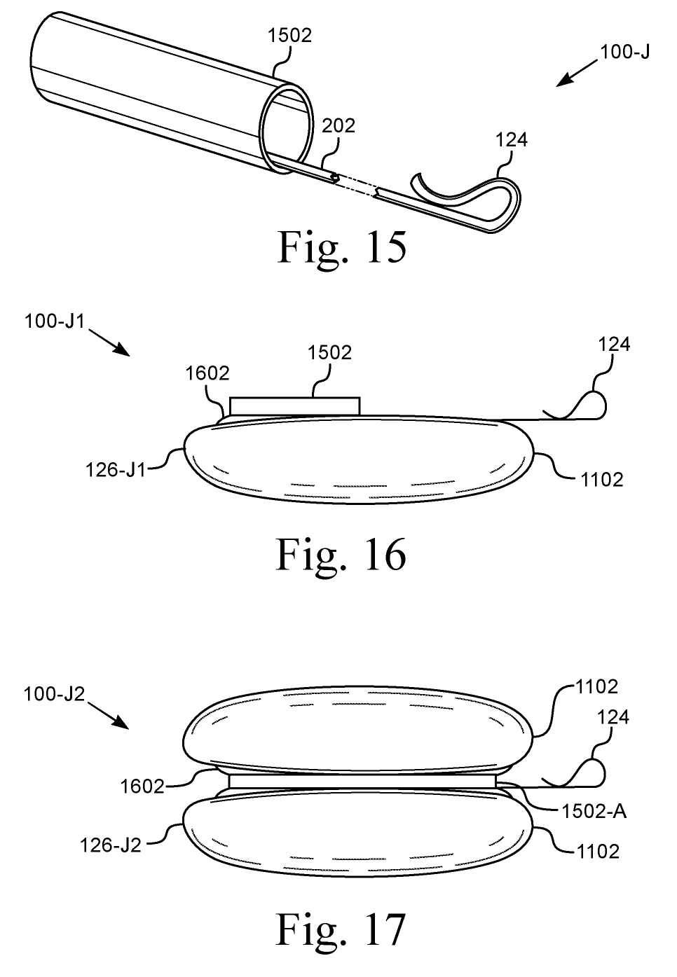

FIG. 15 is a perspective view of yet another embodiment of an attachment device 100-J. A hook end 124 and a shaft 202 are attached to a tubular end or retainer 1502. The tubular end 1502 is dimensioned to receive an end of the fishing line 104. The illustrated attachment device 100-J is configured to have an end of the fishing line 104 threaded through the tube 1502.

FIG. 16 is a side view of one embodiment of an attachment device 100-J1 that includes a piece of tackle 126-J1 included with the attachment device 100-J of FIG. 15. The attachment device 100-J is attached to the piece of tackle 126-J1, such as the illustrated sinker, which has a substantially flat surface on one side and a rounded surface on the other. Protruding from the flatter surface is the tube 1502 located at one end of the piece of tackle 126-J1. The tube 1502 is attached to the tackle 126-J1 with an adhesive 1602 or other compound that fills any gap between the surface of the tackle 126-J1 and the tube 1502. In the illustrated embodiment, the fishing line 104 is routed through the tube 1502 and secured to the in-line snap 124, thereby supporting the piece of tackle 126-J1 in a substantially parallel configuration with the fishing line 104.

FIG. 17 is a side view of another embodiment of an attachment device 100-J2 that includes a piece of tackle 126-J2 included with the attachment device 100-J of FIG. 15. The attachment device 100-J2 is attached to the piece of tackle 126-J2, such as the illustrated sinker. The piece of tackle 126-J2 includes two pieces 1102, such as glass beads, each with a substantially flat surface on one side and a rounded surface on the other, outer side. Protruding from the flatter surfaces is the tube 1502-A. In the illustrated embodiment, the tube 1502-A extends a substantial distance across the flatter surfaces. The tube 1502-A is attached to the piece of tackle 126-J1 with an adhesive 1602 or other compound that fills any gap between the surface of the piece of tackle 126-J2 and the tube 1502-A. In the illustrated embodiment, the fishing line 104 is routed through the tube 1502-A and secured to the in-line snap 124, thereby supporting the piece of tackle 124-J2 in a substantially parallel configuration with the fishing line 104.

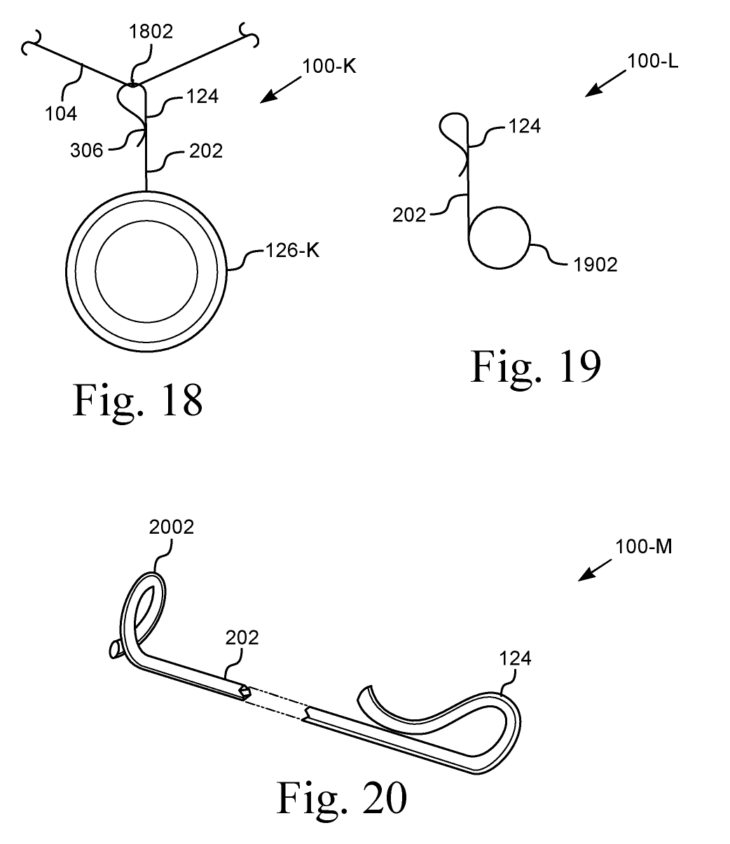

FIG. 18 is a side view of one embodiment of a drop sinker 126-K with one embodiment of an attachment device 100-K. The illustrated drop sinker 126-K is a spherical piece of tackle, such as a ball or marble made of glass, lead, or other dense material that is heavier than water. The shaft 202 is attached to the sinker 126-K with the in-line snap 124 protruding. In one embodiment, the sinker 126-K has a slot that receives the shaft 202, which has a right-angle bend that allows the hook end 124 to project radially from the sinker 126-K. The end of the shaft 202 is glued, crimped, or otherwise secured inside the slot in the sinker 126-K.

The fishing line 104 is secured to the in-line snap 124 with a knot 1802 tied in the middle of the line 104. For example, a butterfly loop is a knot 1802 readily tied in the bight, that is, tied in a continuous section of line 104. The bight engages the in-line snap 124 where the gap 306 prevents the bight of the knot 1802 from slipping out of in-line snap 124.

In another embodiment, the device 100-K is secured to a continuous length of line 104 by wrapping the line 104 such that it engages the in-line snap 124 in a manner as described with respect to FIG. 9. That is, the continuous section of fishing line 104 is wrapped around the shaft 202 with the last wrap pulled past the gap 306 and into the throat 304.

FIG. 19 is a side view of another embodiment of an attachment device 100-L. The shaft 202 connects the hook end 124 to a ring 1902. In the illustrated embodiment, the ring 1902 is coplanar with the hook end 124. The ring 1902 is adapted to connect to an eye of a fishhook, a lure, or a leader. In this way the fishing line 104 is secured to the in-line snap 124 with the ring 1902 providing support for some type of tackle.

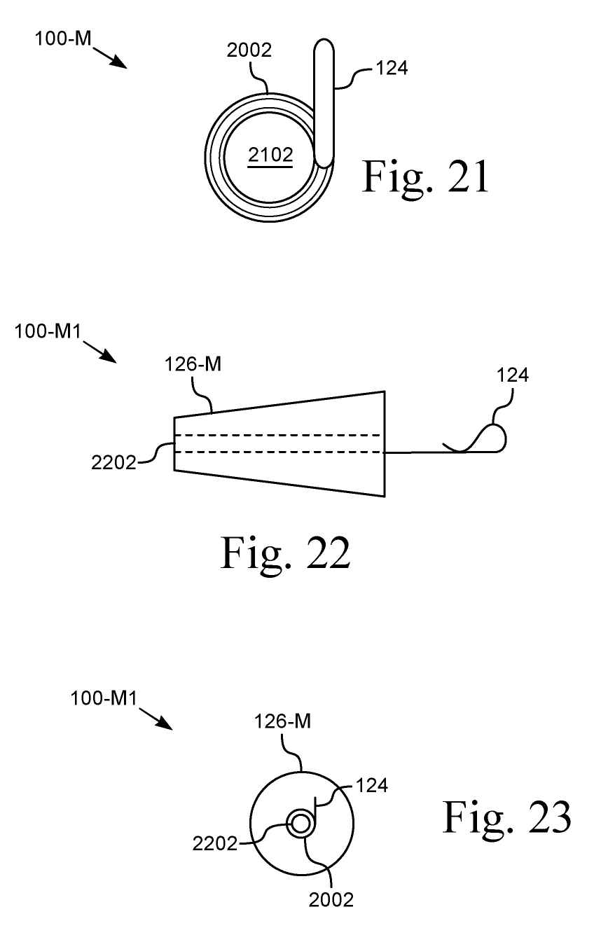

FIG. 20 is a perspective view of still another embodiment of an attachment device 100-M. FIG. 21 is an end view of the embodiment of the attachment device 100-M of FIG. 20. The shaft 202 connects the in-line snap 124 to a ring support 2002. The ring support 2002 has a central axis that is substantially parallel to the shaft 202, but not collinear with it. The in-line snap 124 is offset such that the opening 2102 in the ring support 2002 is unobstructed by the in-line snap 124. In this way the in-line snap 124 does not interfere with a fishing line 104 inserted through the opening 2102. The illustrated attachment device 100-M is configured to have an end of the fishing line 104 threaded through the ring support 2002, such as when the ring support 2002 is attached to a piece of tackle 126-M with a through opening 2202. In another embodiment, the ring support 2002 of the attachment device 100-M is attached, such as with an adhesive, to the surface of the piece of spherical tackle 126-K such as illustrated in FIG. 18. For those embodiments where the device 100-M is attached to a piece of tackle 126-K in the manner illustrated in FIG. 18, the fishing line 104 is not routed through the opening 2102 of the attachment device 100-M.

FIG. 22 is a side view of one embodiment of a piece of tackle 126-M with the attachment device 100-M1 of FIG. 20. FIG. 23 is an end view of the piece of tackle 126-M shown in FIG. 22. The illustrated piece of tackle 126-M is a sinker with a through-hole 2202, such as sinkers commonly made of lead. The ring support 2002 is attached to the sinker 126-M around the opening of the through-hole 2202 such that clear passage of a fishing line 104 is provided through both the through-hole 2202 and the ring support 2002. In the illustrated embodiment, the center axis of the through-hole 2202 is coincident with the center axis of the ring support 2002. The ring support 2002 is attached to the tackle 126-M with an adhesive or is otherwise fixed in place on the piece of tackle 126-M.

In another embodiment, the attachment device 100 includes only a shaft 202 and an in-line snap 124. The shaft 202 is fixed to the piece of tackle 126-M such that the in-line snap 124 is offset from the through-opening 2202 similar to the offset illustrated in FIG. 22.

FIG. 24 is a side view of one embodiment of an attachment device 100-N1 that combines a fish hook 106 with an in-line snap 124 that is oriented with the point 308 on the same side of the shaft 202 as the barb 2402 of the hook 106. FIG. 25 is a side view of another embodiment of an attachment device 100-N2 that combines a fish hook 106 with an in-line snap 124-N2 that is oriented with the point end 308 on the opposite side of the shaft 202 as the barb 2402 of the hook 106. In both embodiments of the attachment device 100-N1, 100-N2, the in-line snap 124, 124-N2 is co-planar with the hook 106.

The embodiment of the in-line snap 124-N2 illustrated in FIG. 25 has a substantially circular bend 310′ and corresponding throat 304′. In this way, a fishing line 104 will be coaxial with the shaft 202 when the fishing line 104 is secured to the in-line snap 124-N2 and the fishing line 104 is pulled in a direction parallel to and away from the shaft 202. The shank 302′ has a bent portion proximate the gap 306. The shank 302′ is attached to the shaft 202 with a collinear relationship. At the bent portion of the shank 302′, the shank 302′ transitions to the bend 310′ to form a substantially circular shape opposite the gap 306. In one embodiment, the bend 310′ and throat 304′ are bisected by a line extending from and collinear with the shaft 202.

The gap 306 in the throat 304, 304′ of the in-line snap 124, 124-N2 is zero. That is, the throat 304, 304′ is closed with no space between the shank 302, 302′ and the portion adjacent the point 308. In this way the fishing line 104 is held captive within the in-line snap 124, 124-N2 and less likely to slide out when a fish bites on the hook 108. In one such embodiment, the distal end of the bend 310, 310′ and point 308 is biased toward the shank 302, 302′ such that a force is required to form a space at the gap 306. In another embodiment, the gap 306 has a space between distal end of the bend 310, 310′ and point 308 less than the thickness of the fishing line 104.

FIG. 26 is a side view of still another embodiment of an attachment device 100-N3 that combines a fish hook 106 with another embodiment of an in-line snap 124-N3. In the illustrated embodiment, the in-line snap 124-N3 is in a plane at right angles to the plane of the hook 106.

The throat 304′ of the in-line snap 124-N3 includes a barb or keeper 2602 near the point 308. The barb 2602 is configured to catch the fishing line 104 that is held captive in the throat 304′ and prevent the fishing line 104 from sliding through the gap 306 and past the point 308. In one embodiment, the barb 2602 is formed into the wire near the gap 306, such as a cut made by a chisel or other tool.

The in-line snap 124, 124-N2, 124-N3 for the attachment device 100-N1, 100-N2, 100-N3 is suited to be secured to the fishing line 104 by engaging an eye 702, such as illustrated in FIG. 1. The point 308 of the in-line snap 124, 124-N2, 124-N3 is inserted in the opening of the eye 702 and the in-line snap 124, 124-N2, 124-N3 is moved relative to the eye 702 such that a portion of the eye 702 engages the throat 304, 304′ inside the in-line snap 124, 124-N2, 124-N3.

The in-line snap 124, 124-N2, 124-N3 for the attachment device 100-N1, 100-N2, 100-N3 is also suited to be secured to the fishing line 104 by a knot 108, 1802. In one embodiment, the attachment device 100-N1, 100-N2, 100-N3 is secured to an end of the fishing line 104 with a knot 108. In another embodiment, the attachment device 100-N1, 100-N2, 100-N3 is secured to a medial section of fishing line 104, and a knot 108 such as a butterfly loop 1802 is used. The knot 108, 1802 has a loop securing the fishing line 104 to the in-line snap 124 of the attachment device 100-N1, 100-N2, 100-N3. The knot 108, 1802 has a loop that remains after being tied. Alternatively, the knot 108, 1802 has a loop exposed when tying the knot, which is when the loop engages the in-line snap 124. The loop in such a knot 108, 1802 closes when the knot 108, 1802 is tightened, such as when tension force is applied between the attachment device 100-N1, 100-N2, 100-N3 and the fishing line 104.

The attachment device 100 includes various functions. The function of frictional sliding engagement is implemented, in one embodiment, by the in-line snap or securing end 124 configured to receive multiple wraps 902, 902-A of the fishing line 104. The number of wraps 902 increasing to increasing the friction between the fishing line 104 and the in-line snap 124.

The function of holding the fishing line 104 captive in the throat 304, 304′ is implemented, in one embodiment, by the distal end of the bend 310, 310′ and the point 308 in contact with the shank 302, 302′. In another such embodiment, the function of holding the fishing line 104 captive in the throat 304, 304′ is implemented by biasing the bend 310, 310′ toward the shank 302, 302′.

From the foregoing description, it will be recognized by those skilled in the art that an apparatus for attaching tackle 126 to a continuous section of fishing line 104 or a loop formed by knotting the fishing line 104 has been provided.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for securing fishing tackle to a continuous section of fishing line, said apparatus comprising:
a first in-line snap having a shank, a bend, and a point, said bend extending from said shank to a gap portion defined by said point, said gap portion having a substantially closed gap, a distal end of said point extending away from said shank, said shank and said bend defining a throat sized and configured to receive a portion of the continuous section of fishing line;
a piece of tackle; and
a shaft connecting said shank of said first inline snap to said piece of tackle.

2. The apparatus of claim 1 further including a second inline snap positioned at an end of said piece of tackle opposite said first inline snap, whereby a fishing line engaging said first and second inline snaps suspends said piece of tackle between said first and second inline snaps.

3. The apparatus of claim 2 wherein said piece of tackle is a sinker.

4. The apparatus of claim 1 wherein said piece of tackle is a fish hook, and a portion of said shaft is coaxial with a shaft of said fish hook.

5. The apparatus of claim 1 wherein said piece of tackle is a fish hook, a portion of said shaft coaxial with a shaft of said fish hook, and said bend including a barb proximate said gap and said barb extending into said throat.

6. The apparatus of claim 1 wherein said shank includes a bent portion whereby a portion of said bend opposite said gap portion has a substantially circular shape.

7. The apparatus of claim 1 wherein said piece of tackle includes an eye, and further includes a second inline snap, said second inline snap positioned at an end of said shaft opposite said first inline snap; and said eye positioned between said first and second inline snaps.

8. The apparatus of claim 1 wherein said piece of tackle includes a coil, said coil having a plurality of spaced apart windings configured to receive the continuous section of fishing line, and said coil separated from said first in-line snap by a distance greater than a length of said coil.

9. The apparatus of claim 1 wherein said gap portion defines a space between said bend and said shank when said point is biased away from said shank when the continuous section of fishing line is pulled through said gap portion.

10. The apparatus of claim 1 wherein said bend is biased toward said shank such that said bend contacts said shank at said gap portion.

11. The apparatus of claim 1 wherein said piece of tackle includes a retainer configured to hold the fishing line captive proximate the piece of tackle as the fishing line extends from said first inline snap.

12. The apparatus of claim 11 wherein said retainer is an eye.

13. The apparatus of claim 11 wherein said retainer is a tube configured to receive an end of the fishing line when the fishing line is secured to said first inline snap.

14. An apparatus for attachable to a continuous section of fishing line, said apparatus comprising:
a first elongate member having a shaft, a shank, a bend, and a point, said shaft being substantially linear, a distal end of said shaft connected to first distal end of said shank, a second distal end of said shank connected to a first distal end of said bend, a second distal end of said bend connected to said point at a gap portion, said second distal end of said bend in contact with said shank, said second distal end of said bend biased toward said shank, and a distal end of said point extending away from said shank,
whereby the continuous section of fishing line forces said second distal end of said bend to move away from said shank when the continuous section of fishing line is moved into said gap portion.

15. The apparatus of claim 14 further including a second elongate member substantially the same as the first elongate member, and said shaft of first elongate member connected to a shaft of said second elongate member

16. The apparatus of claim 15 further including a piece of tackle positioned between said shank of said first elongate member and a shank of said second elongate member.

17. The apparatus of claim 14 further including a piece of tackle connected to said shaft.

18. A method for securing a piece of fishing tackle with a first inline snap to a continuous section of a fishing line, the inline snap having a shank, a bend, and a point, the bend and the shank defining a gap portion therebetween, the shank and bend defining a throat, said method comprising the steps of:
a) wrapping the continuous section of fishing line around the shank for at least two full turns whereby said at least two turns extend from a distal end of said shank to the gap portion;
b) positioning the continuous section of fishing line proximate the gap portion; and
c) pulling the continuous section of fishing line against the gap portion such that the continuous section of fishing line passes through the gap portion and into the throat.

19. The method of claim 18 further including the steps of:
d) wrapping the continuous section of fishing line around the shank of a second inline snap for at least two full turns whereby said at least two turns extend from a distal end of said shank to the gap of said second inline snap, said second inline snap attached to the piece of fishing tackle;
e) positioning the continuous section of fishing line proximate the gap of said second inline snap; and
f) pulling the continuous section of fishing line against the gap of said second inline snap such that the continuous section of fishing line passes through the gap into the throat of said second inline snap.

20. The method of claim 18 further including the steps of:
d) grasping the continuous section of fishing line;
e) grasping the piece of fishing tackle; and then
f) moving the continuous section of fishing line relative to the piece of fishing tackle by applying a tension force between the continuous section of fishing line and the piece of fishing tackle.
